(19) United States
(12) Patent Application Publication
(10) Pub. No.: US 2011/0168518 A1
(43) Pub. Date: Jul. 14, 2011

(54) Vehicle Parking Brake and Method for Operating a Vehicle Parking Brake

(75) Inventor: Eduard HILBERER, Hockenheim (DE)

(73) Assignee: KNORR-BREMSE Systeme fuer Nutzfahrzeuge GmbH, Muenchen (DE)

(21) Appl. No.: 12/842,216

(22) Filed: Jul. 23, 2010

Related U.S. Application Data
(63) Continuation of application No. PCT/EP2009/000197, filed on Jan. 15, 2009.

(30) Foreign Application Priority Data
Jan. 25, 2008 (DE) 10 2008 006 264.2

(51) Int. Cl. F16H 63/34

(52) U.S. Cl. 192/219.4

(57) ABSTRACT

A parking brake and method of operating same are provided for a vehicle. The parking brake is integrated in a transmission of the vehicle. A parking brake actuator is provided to open and close the parking brake, the actuator being bias tensioned via a spring element. A bistable control element is provided, which activates the parking brake actuator to open and close the parking brake.

### CROSS-REFERENCE TO RELATED APPLICATIONS

This application is a continuation of PCT International Application No. PCT/EP2009/000197, filed Jan. 15, 2009, which claims priority under 35 U.S.C. §119 from German Patent Application No. DE 10 2008 006 264.2, filed Jan. 25, 2008, the entire disclosures of which are herein expressly incorporated by reference.

### BACKGROUND AND SUMMARY OF THE INVENTION

The invention relates to a parking brake for a vehicle, which parking brake is integrated into a transmission of the vehicle.

The invention also relates to a method for operating a parking brake integrated into a transmission of a vehicle.

To prevent a parked vehicle from inadvertently rolling away, an extremely wide variety of types of vehicles which can be used on the road or on rails conventionally have a parking brake. The parking brake is suitably designed to block at least some of the vehicle wheels which permit a rolling movement during driving operation of the vehicle.

A disadvantage of such designs is that a device which imparts a braking action, for example a spring brake cylinder, must be provided on each vehicle wheel to be braked, such that the structural expenditure for the parking brake is very high. If the device which imparts the braking action is simultaneously used on the vehicle by a service brake of the vehicle, such as in the case of a spring brake cylinder, then it is additionally necessary to protect against two-fold loading which may occur in the event of a simultaneous actuation of the parking brake and service brake.

In connection with DE 10 2004 055 960 A1, it is already known for the parking brake to be integrated into a transmission of the vehicle, with use being made of a multiplate brake, which may also be used as a retarder.

The invention is based on the object of providing a parking brake which is of simple construction and which has enhanced safety functionality.

The invention builds on the generic parking brake in that a parking brake actuator is provided for opening and closing the parking brake, which parking brake actuator is preloaded by use of a resilient element, and in that a bistable actuating element is provided which activates the parking brake actuator so as to open and close the parking brake. As a result of the bistable actuating element, the parking brake actuator pauses in the present state if there is a defect in the components which activate the bistable actuating element. A sudden opening or closing of the parking brake by a monostable actuating element as a result of such a defect can thereby be prevented. The energy required for closing the parking brake may be stored in the resilient element, for example a spring or a rubber element, such that energy in the form of pressure medium need be supplied only for opening the parking brake.

Here, it may also be provided that a control unit, which is assigned to the parking brake, is suitable for locking at least one differential of the vehicle. As a result of the locking of at least one differential of the vehicle, the rotational movement of at least two vehicle wheels is synchronized, and therefore a braking action is distributed uniformly between the coupled vehicle wheels. The vehicle wheels of a single axle can be coupled to one another as a result of the locking of a transverse differential, while the rotational movement of different axles can be rigidly coupled to one another as a result of the locking of a longitudinal differential. The locking of at least one differential in conjunction with the closing of the parking brake of the vehicle therefore results in the braking action imparted by a single device being distributed uniformly between the vehicle wheels which are coupled by way of the locked differential.

It is expediently provided that the bistable actuating element can be activated in pulse-width-modulated fashion. The possibility of pulse-width-modulated activation of the bistable actuating element permits a graduable adaptation of the braking action of the parking brake.

Here, it is advantageously provided that the control unit which, is assigned to the parking brake, is suitable for controlling a transmission of the vehicle. The integration of the parking brake into the transmission of the vehicle results in spatial proximity of the components of the parking brake and the transmission, which may be utilized to save on a control unit, for example a transmission control unit.

Here, it may be provided that the control unit, which is assigned to the parking brake, is suitable for controlling a clutch of the vehicle. The clutch of the vehicle is conventionally arranged between a drive (engine or motor) and the transmission of the vehicle, directly upstream of the transmission. This spatial proximity can ideally be utilized to save on a further control unit, for example a control unit which controls the clutch, especially since the actuation of the clutch often correlates with an actuation of the transmission.

It may also be provided that the parking brake actuator is connected downstream of a transmission input stage. The braking action, which can be transmitted to the vehicle wheels, is dependent on the arrangement of the parking brake actuator within the transmission, because with each transmission stage, the torques occurring during a rotation of the vehicle wheels are changed. The arrangement of the parking brake actuator downstream of a transmission input stage is therefore expedient as a function of the torque transmitted from the vehicle wheels to the parking brake actuator.

It may also be expedient for the parking brake actuator to be connected upstream of a transmission output stage. In this arrangement, too, the torque conversion which takes place in the transmission output stage can have an advantageous effect on the braking action of the parking brake.

It may expediently also be provided that the control unit, which is assigned to the parking brake, is suitable for closing the parking brake when an ignition of the vehicle is switched off. Switching off the ignition of the vehicle is usually one of the last actions carried out by the driver when shutting down the vehicle before leaving his driver's position. As a result of the automatic closure of the parking brake when the ignition is switched off, it is therefore ensured that no adverse effects in the form of an unsecured vehicle arise if the driver inadvertently forgets to engage the parking brake.

The generic method is refined in that a parking brake is preloaded by use of a resilient element and in that the parking brake actuator is actuated by the activation of a bistable actuating element which opens or closes the parking brake.

In this way, the advantages and features of the parking brake according to the invention are also implemented within the context of a method.

This also applies to the particularly preferred embodiments of the method according to the invention as specified below.

The method is expediently refined in that, during the actuation of the parking brake, at least one differential of the vehicle is locked. It is expediently provided that the bistable actuating element is activated in pulse-width-modulated fashion. It is advantageously provided that the control unit which is assigned to the parking brake controls a transmission of the vehicle. It may also be provided that the control unit which is assigned to the parking brake controls a clutch of the vehicle. It may also be provided that the parking brake is closed after an ignition of the vehicle is switched off.

It may be provided in particular that the dismounting of the parking brake takes place as a first step during a dismounting of the transmission and that the mounting of the parking brake takes place as the final step during a mounting of the transmission. This mounting/dismounting sequence permits a modular exchange of the parking brake without cumbersome dismounting of the transmission, as a result of which the servicing expenditure can be reduced if the parking brake is worn and must be replaced.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic illustration of a vehicle having a parking brake according to the invention;

FIG. 2 is an enlarged illustration of a parking brake according to the invention; and

FIGS. 3a-3e show the interaction of different parameters over time during the operation of the parking brake.

### DETAILED DESCRIPTION OF THE DRAWINGS

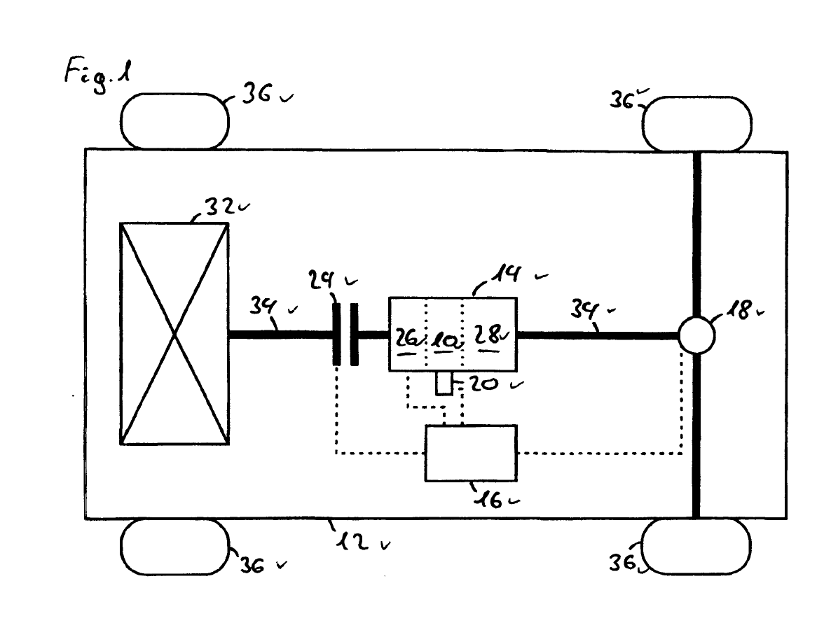

FIG. 1 is a diagrammatic illustration of a vehicle having a parking brake according to an embodiment of the invention. An illustrated vehicle 12 with vehicle wheels 36 is driven by a drive engine 32 via a drivetrain 34, with the force imparted by the drive engine 32 being transmitted via a differential 18 to the rear vehicle wheels 36 of the vehicle 12. Also arranged in the drivetrain 34 are a clutch 24 and a transmission 14, with the transmission 14 having a transmission input stage 26, a transmission output stage 28 and a parking brake 10 arranged between the transmission input stage 26 and the transmission output stage 28. A control unit 16 is coupled via lines to the clutch 24, to the differential 18 and to the transmission 14, with a separate coupling of the control unit 16 to the parking brake 10 by way of a bistable actuating element 20 that is provided as used herein, a bistable actuating element 20 is an actuating element which maintains its present switching position in the event of a loss of the pilot control signal, which may be pneumatic, electric or hydraulic. The bistable actuating element 20 may, for example, be constructed by use of rotary detents, sliding detents or friction elements such as O-rings, which simultaneously perform a sealing function. A magnetic lock for positional fixing and self-locking spindles are likewise contemplated. The control unit 16 can open and close the clutch 24, lock and unlock the differential 18, shift the transmission 14 and open and close the parking brake 10. The parking brake 10 can therefore brake the two rear vehicle wheels 36 uniformly when it is closed by the control unit 16 and the control unit 16 simultaneously locks the differential 18.

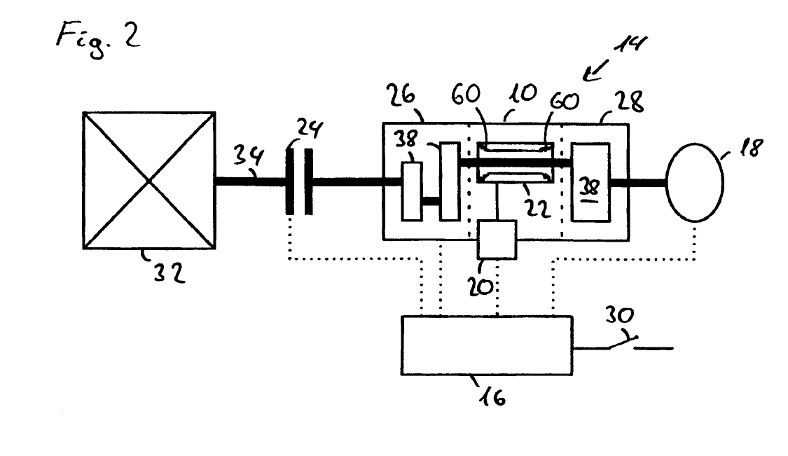

FIG. 2 shows an enlarged illustration of a parking brake according to an embodiment of the invention. The transmission 14 in particular is shown in more detail. The transmission input stage 26 includes two transmission ratios 38 which can selectively be selected together or individually by a transmission actuator (not illustrated) by way of the control unit. The transmission output stage 28 also has a transmission ratio 38. The transmission ratios 38 may for example be designed as gearwheel pairs and/or sun gears and planet gears.

Between the transmission input stage 26 and the transmission output stage 28, the parking brake 10 is again integrated into the transmission 14, with the parking brake actuator 22 which surrounds a shaft and which is preloaded by a resilient element 60 being shown. The parking brake actuator 22 is activated by the bistable actuating element 20 by way of the control unit 16 and is restored by way of the resilient element 60, for example a spring. The parking brake actuator may be actuated by the bistable actuating element 20 electrically, that is to say by way of an electric motor, or by way of a pneumatic or hydraulic cylinder. The medium supply to the bistable actuating element 20 and to the parking brake actuator 22 may in particular be realized here in redundant form by use of two separate medium supply lines (not illustrated), with the medium supply to the transmission 14 and to the parking brake 10 advantageously being realized by a common medium supply. The element which rotates relative to the housing of the transmission 14 is then braked by friction with a brake lining moved by the parking brake actuator 22, with the forces which are generated being absorbed via the stationary housing of the transmission 14.

The parking brake actuator 22 is capable, on account of the bistable actuating element 20, of maintaining its present position if an ignition 30 is switched off or the power supply fails, because the medium supply is not suddenly interrupted. The moving element to be braked is preferably a disk or a wheel, which is rotationally fixedly connected to the driveshaft. Here, it is not necessary for the parking brake actuator 22 to surround the shaft. The parking brake actuator 22 need merely be positioned such that it can press a brake lining against a part to be braked. The parking brake actuator 22 is also designed such that, in the case of an auxiliary brake assistance, it automatically opens during a ventilation of the service brake. In a hydraulic or pneumatic parking brake system, this is achieved in that there is an actuator, for example a cylinder, which is restored by a further resilient element, for example a spring. Furthermore, however, at least one associated pilot control valve is of bistable design.

The cylinder spring effect is obtained in the case of an electric motor by use of an additional elastic application element, for example a spring or a rubber block, which is arranged in a serial direction of action with respect to the electric motor axle. The control unit 16 has a connection to a vehicle bus, by which the control unit 16 can exchange information relating to the vehicle state with other control units, for example an EBS control unit and an engine controller. Furthermore, the control unit 16 has a wake-up circuit and a read-write memory for storing status information which may be used for example during the course of a subsequent vehicle diagnosis. In the case of an ECPB regulation, in the event of an auxiliary braking assistance, the bistable actuating element 20 permits braking of the spinning vehicle wheel and therefore a stabilization of the vehicle by limiting the differential compensation capability. This is similar to an ASR functionality. A TCM module (not illustrated) performs a test function and combination coordination during partial braking operations in the event of the service braking assistance in the case of a partial EBS failure if the vehicle is a vehicle combination, that is to say a tractor vehicle with a trailer.

A manually operated control unit detects a driver demand relating to an opening or closing of the parking brake. The manually operated control unit has a movable element, for example a lever, a rocker or a button, and a stationary element. The relative movements of these parts in relation to one another can be measured. Here, by means of a detection of intermediate positions, it is possible to detect a desired gradual braking action. The signal transmission to the control unit 16 may take place in digital or analog form, wherein a redundancy should be provided, that is to say the transmission of a single driver demand via two mutually separate paths, for example two separate cables. The manually operated control unit permits a wake-up of the control unit 16 of the parking brake 10 either via a vehicle bus, for example the CAN bus, or a separate line. This permits a wake-up of the control unit 16 in particular in a parked vehicle and permits at least a closing of the parking brake 10. The opening of the parking brake 10 may however likewise be provided.

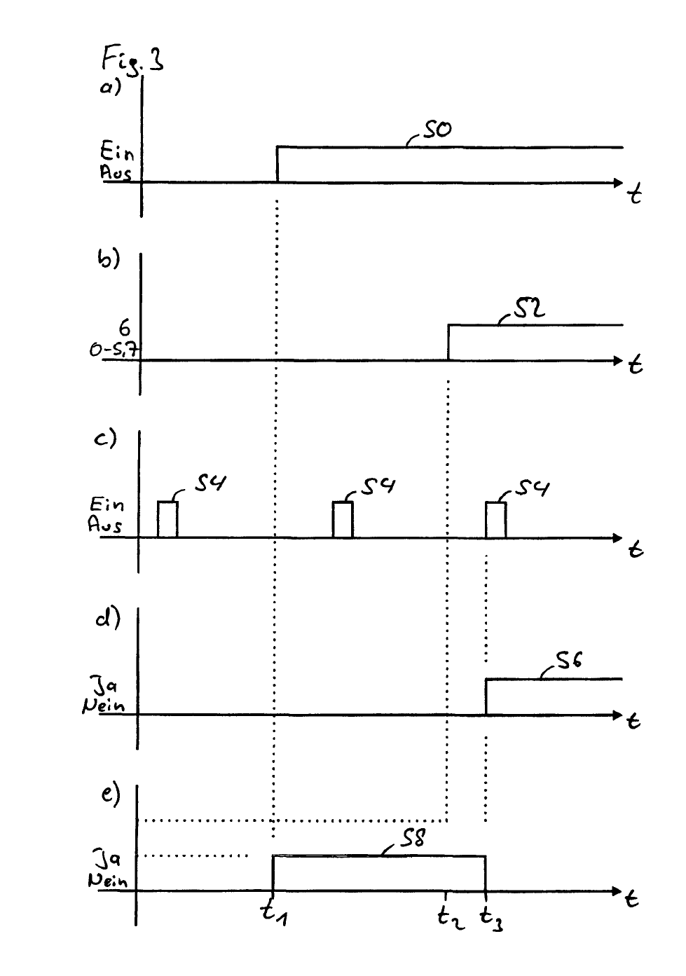

FIGS. 3a-3e show the interaction of different parameters over time during the operation of the parking brake. A curve 50 in FIG. 3a shows the status of the ignition, which is switched on at a time t₁. FIG. 3b shows a curve 52 of the pressure, wherein at a time t₂ after t₁ the required auxiliary brake pressure of 6 bar has been built up. FIG. 3c shows the profile over time of the activation status of the driver presence check as a curve 54. The driver presence check is activated in each case for a short period of time. FIG. 3d shows, in a curve 56, the enablement status of the parking brake. The parking brake is enabled at a time t₃ after t₂. FIG. 3e, in a curve 58, indicates the status of a warning message which signals a locked parking brake. The interaction of the individual parameters will be explained below.

Firstly, before the time t₁, an only intermittent activation of the driver presence check takes place. At t₁, the ignition is activated and, since a sufficient pressure for an auxiliary braking is not yet present, a corresponding warning is output, while simultaneously the pressure build-up is initiated after the drive engine is started. At the time t₂, a sufficient pressure for an auxiliary braking is present, but the presence of the driver has not yet simultaneously been checked. Only when this has likewise been positively confirmed at the time t₃ is the warning message extinguished and the parking brake is enabled.

Table of Reference Numerals

| | |
|---|---|
| 10 | Parking brake |
| 12 | Vehicle |
| 14 | Transmission |
| 16 | Control unit |
| 18 | Differential |
| 20 | Bistable actuating element |
| 22 | Parking brake actuator |
| 24 | Clutch |
| 26 | Transmission input stage |
| 28 | Transmission output stage |
| 30 | Ignition |
| 32 | Drive engine |
| 34 | Drivetrain |
| 36 | Vehicle wheel |
| 38 | Transmission ratio |
| 50 | Status of ignition |
| 52 | Pressure curve |
| 54 | Status of driver presence check |
| 56 | Enablement of parking brake |
| 58 | Warning “parking brake locked” |
| 60 | Resilient element |

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A parking brake for a vehicle, which parking brake is integrated into a transmission of the vehicle, comprising:
a parking brake actuator for opening and closing the parking brake, the parking brake actuator being preloaded by a resilient element; and
a bistable actuating element operatively configured to activate the parking brake actuator so as to open and close the parking brake.

2. The parking brake according to claim 1, further comprising a control unit assigned to the parking brake, the control unit being operatively configured for locking at least one differential of the vehicle.

3. The parking brake according to claim 2, wherein the bistable actuating element is activatable in a pulse-width-modulated fashion.

4. The parking brake according to claim 2, wherein the control unit is further operatively configured for controlling the transmission of the vehicle.

5. The parking brake according to claim 2, wherein the control unit is further operatively configured for controlling a clutch of the vehicle.

6. The parking brake according to claim 4, wherein the control unit is further operatively configured for controlling a clutch of the vehicle.

7. The parking brake according to claim 1, wherein the parking brake actuator is connected downstream of a transmission input stage of the transmission.

8. The parking brake according to claim 1, wherein the parking brake actuator is connected upstream of a transmission output stage of the transmission.

9. The parking brake according to claim 1, wherein the control unit is further operatively configured for closing the parking brake when an ignition of the vehicle is switched off.

10. A method for operating a parking brake integrated into a transmission of a vehicle, the method comprising the acts of:
preloading a parking brake actuator for the parking brake via a resilient element; and
actuating the parking brake actuator via activation of a bistable actuating element that opens or closes the parking brake.

11. The method according to claim 10, further comprising the act of locking at least one differential of the vehicle during actuation of the parking brake.

12. The method according to claim 10, further comprising the act of activating the bistable actuating element in a pulse-width-modulated fashion.

13. The method according to claim 11, further comprising the act of activating the bistable actuating element in a pulse-width-modulated fashion.

14. The method according to claim 10, further comprising the act of controlling the transmission of the vehicle via a control unit that is assigned to the parking brake.

15. The method according to claim 10, further comprising the act of controlling a clutch of the vehicle via a control unit that is assigned to the parking brake.

16. The method according to claim 10, further comprising the act of closing the parking brake after an ignition of the vehicle is switched-off.

17. A method for mounting and dismounting a parking brake integrated into a transmission of a vehicle, the parking brake having a parking brake actuator preloaded by a resilient element wherein the parking brake actuator is actuated by a bistable actuating element, the method comprising the acts of:
during a dismounting of the transmission, as a first step dismounting the parking brake; and
during a mounting of the transmission, in a final step takes mounting of the parking brake.

18. A vehicle, comprising:
a parking brake for a vehicle, which parking brake is integrated into a transmission of the vehicle;
a parking brake actuator for opening and closing the parking brake, the parking brake actuator being preloaded by a resilient element; and
a bistable actuating element operatively configured to activate the parking brake actuator so as to open and close the parking brake.

19. The vehicle according to claim 18, further comprising a control unit assigned to the parking brake, the control unit being operatively configured for locking at least one differential of the vehicle.

20. The vehicle according to claim 18, wherein the bistable actuating element is activatable in a pulse-width-modulated fashion.
